(19) United States
(12) Patent Application Publication
(10) Pub. No.: US 2007/0206845 A1
(43) Pub. Date: Sep. 6, 2007

(54) Granularity analysis in cellular phenotypes

(75) Inventors: Aibing Rao, Burlingame, CA (US); Eugeni A. Vaisberg, Foster City, CA (US)

Correspondence Address: BEYER WEAVER LLP, P.O. BOX 70250, OAKLAND, CA, 94612-0250, US

(73) Assignee: Cytokinetics, Inc.

(21) Appl. No.: 11/651,912

(22) Filed: Jan. 9, 2007

Related U.S. Application Data
(60) Provisional application No. 60/757,597, filed on Jan. 9, 2006.

(30) Foreign Application Priority Data
Mar. 8, 2006 (GB) 0604653.6

(51) Int. Cl. G06K 9/00

(52) U.S. Cl. 382/133

(57) ABSTRACT

Methods and apparatus, including computer program products, implementing and using techniques for analyzing images of cells and extraction of biologically significant features from the cell images, such as from granules representing intercellular organelles or other features in the images. In various embodiments, the extracted features can include the number of granules, the total surface area of the granules, the mean or maximum intensities of the granules, etc. These features can be determined on a cell-by cell basis, or for particular regions within a single cell, or for various groups of cells.

The present invention relates to methods and apparatus, including computer program products, for analyzing images of biological systems such as individual cells.

This application is related to US Patent Publication No. US 2005-0014217 A1 of Mattheakis et al., published Jan. 20, 2005, and titled “PREDICTING HEPATOTOXICITY USING CELL BASED ASSAYS,” and to US Patent Publication No. US 2005-0014216 of Mattheakis et al., published Jan. 20, 2005, and titled “PREDICTING HEPATOTOXICITY CELL BASED ASSAYS,” both of which are incorporated herein by reference for all purposes.

Many interesting biological conditions can be correlated with features and conditions that occur on a cellular level. Biological “conditions” of interest to researchers include, for example, disease states, normal unperturbed states, quiescent states, states induced by exogenous biologically-active agents, and so on. Valuable insight may be gained by inducing a biological condition through a genetic manipulation, exposure to a particular agent (e.g., a chemical compound, radiation, electromagnetic field, and so on), deprivation of required substance, and other perturbations. Such a condition may cause changes in the occurrence and/or distribution of various proteins and other subcellular components within a cell. Conversely, detection of the presence and/or distribution of such proteins and subcellular components within the cell may be indicative of that particular condition.

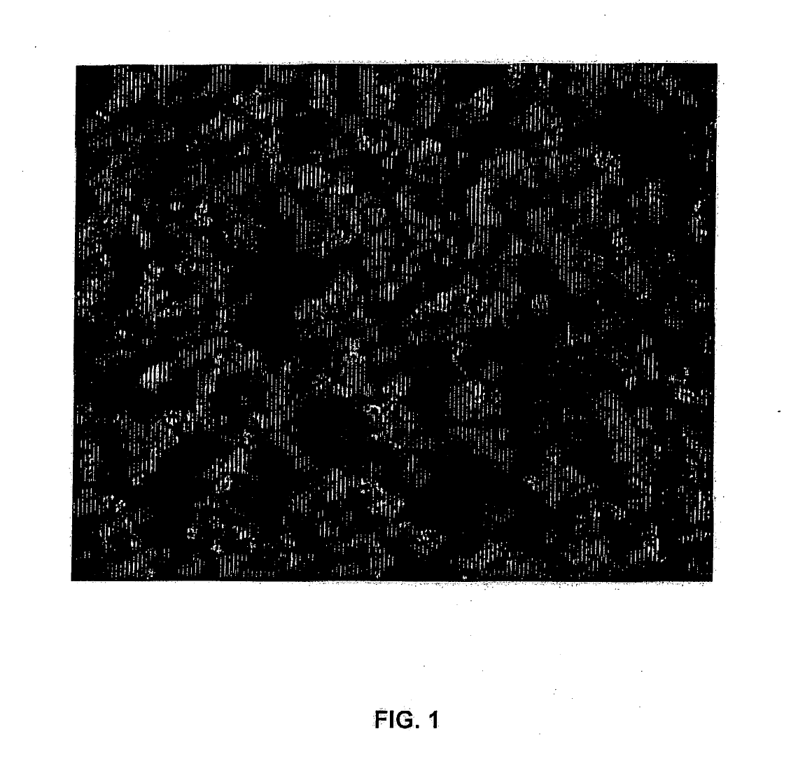

In drug discovery, valuable information can be obtained by understanding how a potential therapeutic agent affects a cell. This information may give some indication of the mechanism of action associated with the compound. For example, various drugs may induce changes in the distribution and staining intensity of various intracellular organelles (for example, lipid granules, lysosomes, mitochondria, and so on.). Having the ability to quickly analyze changes in the quantity, distribution, or intensity in images of intracellular organelles in a large number of cells may be useful in characterizing drug effects. In conventional images of cells, intracellular organelles may be visible as granules in the images. FIG. 1 shows an example image of rat hepatocytes, obtained with a microscope at 10× magnification, where lipid granules are visible as tiny bright spots. Some of the main challenges of conducting granularity analysis in an image such as the one shown in FIG. 1 arise from the need to reliably discriminate between the granularity signal and the object and/or background signal.

Provided are methods and apparatus for the analysis of images of cells and extraction of biologically significant features from the cell images, for example, from granules representing intercellular organelles or other features in the images. In various aspects, the extracted features can include, for example, the number of granules, the total surface area of the granules, the mean or maximum intensities of the granules, and the like. These features can be determined on a cell-by cell basis, or for particular regions within a single cell, or for various groups of cells. The extracted features may be correlated with particular conditions induced by biologically-active agents with which cells have been treated, thereby enabling the automated analysis of cells based on features that can be discovered by granularity analysis of the images.

Disclosed are algorithms for image granularity analysis. In some aspects, such algorithms detect and quantify objects, which are substantially smaller than cells (typically a few pixels in diameter in images recorded at standard magnifications (e.g., 10×)). Such algorithms may take advantage of the fact that granules in an image of a population of cells can be identified as areas in the image where an edge (that is, a steep gradient in signal intensity) can be found close to (typically within a few pixels at typical magnification and resolution) a local intensity maximum. Thus, by combining an edge detection analysis of an image with a local intensity detection analysis of the image, the granules can be located and quantified within the image.

Certain aspects provide methods and apparatus, including computer program products, implementing and using techniques for characterizing one or more cell features relating to intra-cellular granules within biological cells. An image of one or more cells is received in which a marker identifies at least one type of intra-cellular granules within the cells, the intra-cellular granules being visible in the image. Edges and local intensity maxima are detected in the received image. The detected local intensity maxima are dilated. Intersection positions where the dilated local intensity maxima intersect detected edges are identified in the image. The identified intersection positions are dilated to define granules within biological cells of the image.

Certain aspects can include one or more of the following features. Dilating the detected local intensity maxima can include dilating the maxima to a size that corresponds to an expected size of a granule in the image. The image can include a digital representation of the one or more cells. The cells can be hepatocyte cells. Detecting edges can include processing each pixel in the received image with a Sobel mask to generate a derivative image in which each pixel has an associated gradient value; and designating a pixel as an edge pixel if the gradient value of the pixel is larger than a predetermined threshold value. The predetermined threshold value can be one of: a median absolute gradient value for the pixels in the derivative image, a mean absolute gradient value for the pixels in the derivative image, and an upper 25^{th} percentile gradient value for the pixels in the derivative image.

Detecting local intensity maxima can include comparing an intensity value of each pixel in the image with the intensity values of its neighboring pixels within a defined distance, and designating a pixel as a local intensity maximum if its intensity value is greater than or equal to the intensity values of all its neighboring pixels. The received image can be obtained with 10× magnification and dilating the detected local intensity maxima can include dilating the local intensity maxima to three by three pixels. The received image can be obtained with 10× magnification and dilating the intersection can include dilating the intersection to three by three pixels to define a granule. The intra-cellular granules can include one or more of the following types of cellular structures: lipid granules, lysosomes, and mitochondria.

The received image can be segmented to identify cell boundaries for the individual cells in the field of one or more cells. Segmenting can include using a watershed algorithm to segment the cells. One or more features relating to the identified granules can be characterized on a per cell or per cell domain basis. The features can include one or more of: the number of granules, the total size or area of the granules, the total intensity of the granules and the average intensity of the granules. The features can be characterized within one or more of the following types of regions: a particular area within a cell, a one or more whole cells within the image, and one or more groups of cells within the image. The image can be a post treatment image of cells after treatment with a compound, and characterizing one or more features relating to the granules can include comparing the features of the post treatment image with a pre treatment image to identify the induced changes of features in the post treatment image. Dose curves can be generated, which show the variation of features for different concentrations of a drug to determine an effective concentration of the drug.

Various biological conditions of interest involving changes pertaining to granules can be automatically identified through image processing techniques. Valuable insight of molecular mechanisms may be gained by inducing biological conditions by various means, such as genetic manipulation, exposure to a particular agent, deprivation of required substance, and other perturbations, and using the image analysis to study the results. In certain aspects the distributions of image granules within hepatocytes can be used to indicate pathologies such as cholestasis, phospholipidosis or steatosis.

One or more embodiments of the invention will now be described in detail, by way of example only, and with reference to the accompanying drawings and the description below. Other features and advantages will be apparent from the description and drawings, and from the claims.

FIG. 1 is an exemplary image of rat hepatocytes stained to indicate granules.

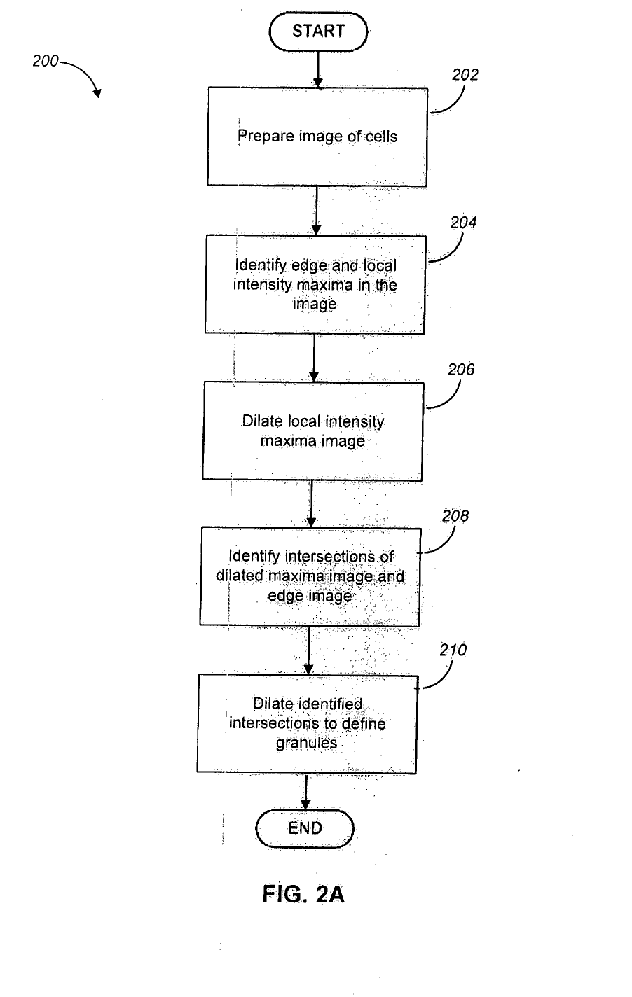

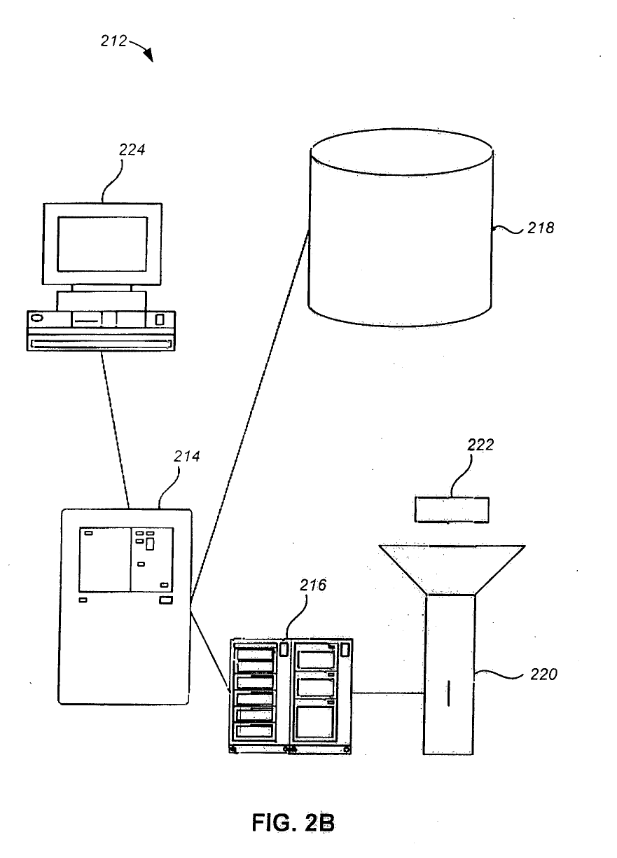

FIG. 2A is a flowchart showing an image analysis process.

FIG. 2B is a schematic block diagram of an image capture and image processing system.

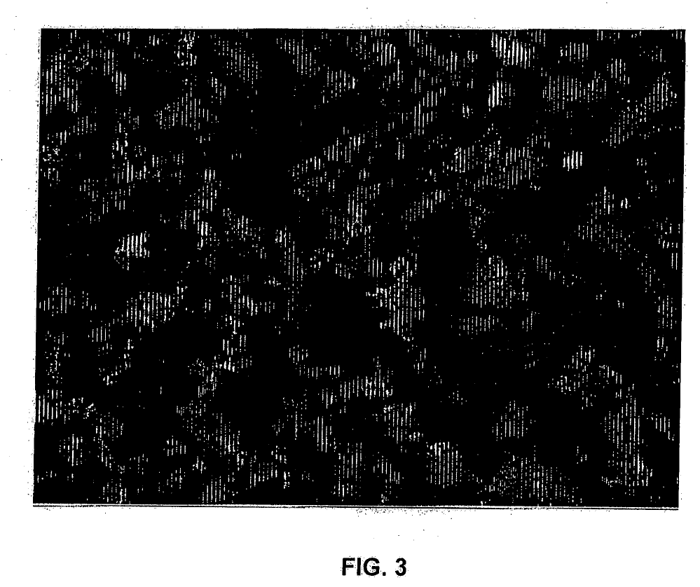

FIG. 3 is the same image as in FIG. 1, with edges detected by a Sobel edge detection algorithm.

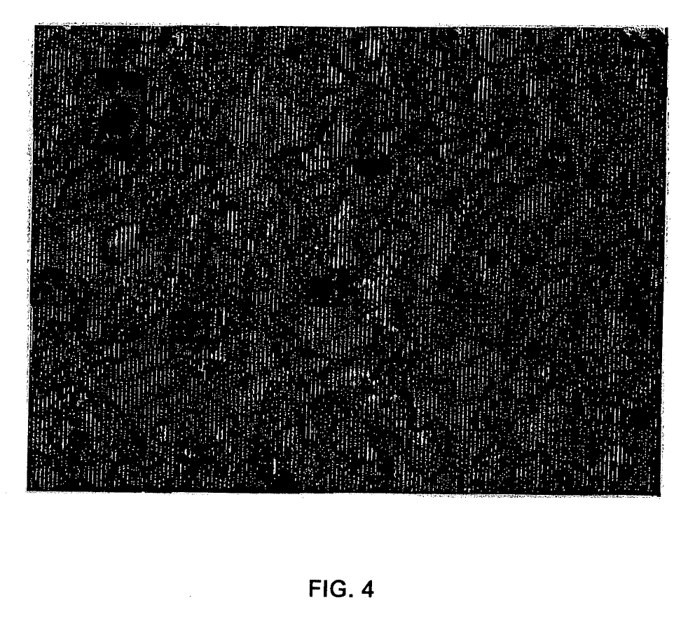

FIG. 4 is the same image as in FIG. 1, with local maximum intensity pixels identified.

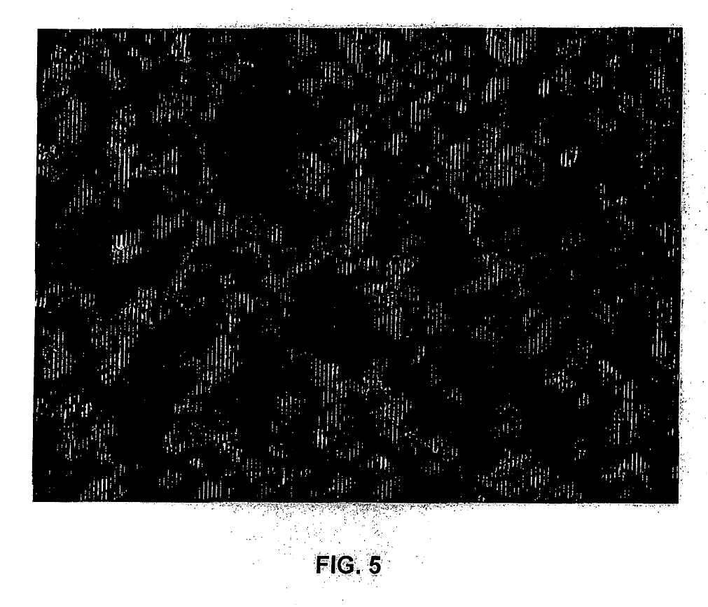

FIG. 5 is the same image as in FIG. 1, with granules detected.

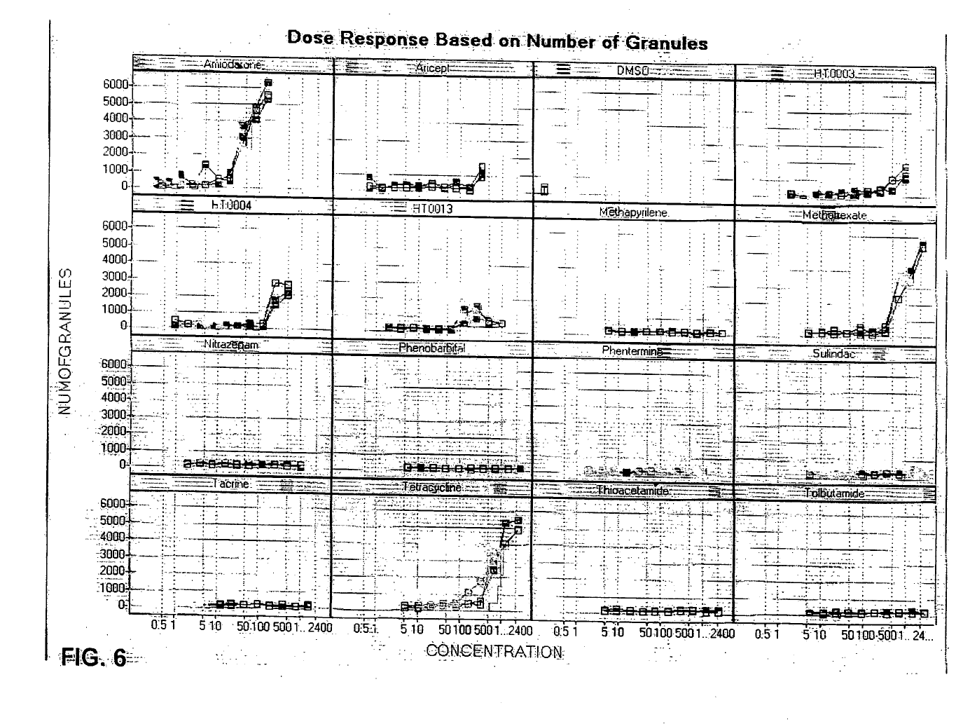

FIG. 6 shows a set of dose response curves for various drugs, based on the number of granules detected.

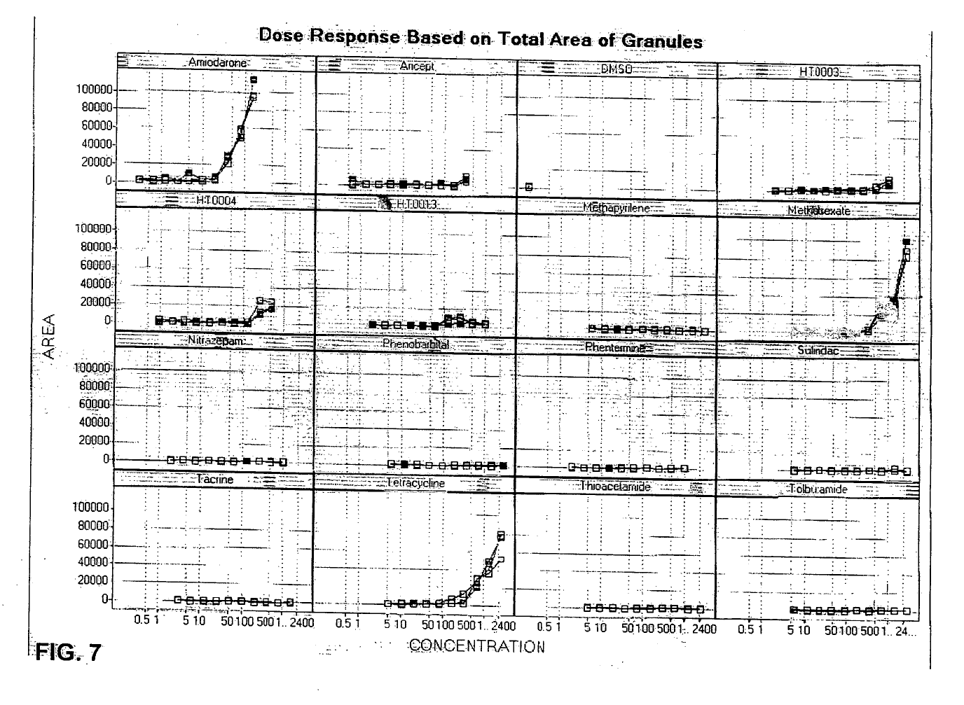

FIG. 7 shows a set of dose response curves for various drugs, based on the area of the granules detected.

Like reference symbols in the various drawings indicate like elements.

Generally, provided are image analysis processes and apparatus configured for image analysis, as well as machine-readable media on which is provided instructions, data structures, and so on, for performing the processes. Images of cells are manipulated and analyzed in certain ways to extract relevant intra-cellular features. Using those features, the apparatus and processes can automatically draw certain conclusions about the biology of a cell or a group of cells.

Provided are methods and apparatus for analysis of images of cells and extraction of biologically significant features from the cell images, such as from granules representing intracellular organelles in the images. In various embodiments, the extracted features can include, for example, the number of granules, the total surface area of the granules, the mean or maximum intensities of the granules, and the like. As indicated, these features can be determined on a cell-by cell basis, or for particular regions within a single cell, or for various groups of cells. The extracted features may be correlated with particular conditions induced by biologically-active agents with which cells have been treated, thereby enabling the automated analysis of cells based on features that can be discovered by granularity analysis of the images.

Certain embodiments provide algorithms for image granularity analysis, which, for example, detect and quantify objects which are substantially smaller than cells (typically a few pixels in diameter in images recorded at standard magnifications and image resolutions). The algorithms are based on the insight that granules in an image of a population of cells can be identified as areas in the image where an edge (that is, a steep gradient in signal intensity) can be found close to (typically within a few pixels at typical magnification and resolution) a local intensity maximum. Thus, by combining an edge detection analysis of an image with a local intensity detection analysis of the image, the granules can be located and quantified within the image.

Examples of specific embodiments are illustrated in the accompanying drawings. While the methods and apparatus are described in conjunction with these specific embodiments, it will be understood that this description is not intended to be limited to the described embodiments. On the contrary, the description is intended to cover alternatives, modifications, and equivalents as may be included within the scope of the appended claims. In the following description, specific details are set forth in order to provide a thorough understanding of the methods and apparatus. The methods and apparatus can be practised without some or all of these specific details. In addition, well-known features or details may not have been described to avoid unnecessarily obscuring the essential features of the methods and apparatus.

FIG. 2A shows a flowchart of a process (200) for obtaining and processing images in accordance with one embodiment. As can be seen in FIG. 2, the process starts with receipt of or preparation of an image of cells to be analyzed (step 202). The image is then processed to identify edges in the image and to identify local intensity maxima in the image (step 204). It should be noted that although the edge detection and the identification of local intensity maxima can be done on a cell-by-cell basis, certain embodiments involve traversing the entire image pixel-by-pixel one or more times to detect edges and to find local maxima.

Once an edge image and a local maxima image have been defined, the local intensity maxima are dilated (step 206) by a predetermined number of pixels. Granule intensities are typically very bright, but in order to be confident that these bright spots originate from granules and not from other parts of the cells, it is necessary to determine whether there is an edge close to the local intensity maximum, which is one reason why the local intensity maxima are dilated. After dilating the local maxima, intersections of the dilated local maxima and the edges detected in step 204 are identified (step 208). These intersections are then deemed to identify granule boundaries within the image. Finally, the identified intersections are dilated to define regions of the image occupied by the granules (step 210). The identified granules may then be used to further characterize and draw conclusions about various biological conditions, for example, by associating the granules with individual cells, with regions within a single cell, or with groups of cells. Each of the steps of the process (200) in FIG. 2A will now be discussed in further detail, followed by some illustrative examples that show various features that can be detected in accordance with the various embodiments.

Images may be obtained of cells that have been treated with a chemical agent to render visible (or otherwise detectable in a region of the electromagnetic spectrum) a cellular component. A common example of such agents are colored dyes specific for a particular cellular component that is indicative of cell periphery features, which enables the identification of various intracellular organelles, such as lipid granules, lysosomes, mitochondria, and so on that can be further analyzed. Other such agents may include fluorescent, phosphorescent or radioactive compounds that bind directly or indirectly (for example, through antibodies or other intermediate binding agents) to a cell component. Several cell components may be treated with different agents and imaged separately. Some of these may be useful for identifying cells and cell boundaries (e.g., DNA markers to identify nuclei and non-specific cell protein markers to identify cell boundaries).

Generally the images used as the starting point for the methods are obtained from cells that have been specially treated and/or imaged under conditions that contrast markers of intracellular components of interest from other cellular components and the background of the image. In certain embodiments, the cells are fixed and then treated with a material that binds to a marker for the components of interest and shows up in an image. The chosen imaging agent can be chosen to bind indiscriminately with the marker, regardless of its location in the cell. The agent should provide a signal related to a cellular component of interest. To this end, the agent should be luminescent, radioactive, fluorescent, etc. Various stains and fluorescent compounds may serve this purpose. A variety of imaging agents are available depending on the particular marker, and agents appropriate for labelling various intracellular organelles, as well as for labelling cytoskeletal, cytoplasmic, plasma membrane, nuclear, and other discrete cell components that may be used as reference points when viewing the organelles are well known in the histology art.

Cells may be treated with more than one imaging agent, each imaging agent specific for a different cellular component of interest. In case of fluorescent markers the component(s) may then be separately imaged by separately illuminating the cells with an excitation frequency and/or by use of appropriate emission filters (channels) for the imaging agents of markers for components of interest. Thus different images of the same cells focusing on different cellular components may be obtained on different channels, and imaged in the same resulting image, if so desired.

Various techniques for preparing and imaging appropriately treated cells are described in U.S. patent application Ser. No. 09/310,879 by Vaisberg et al., filed May 14, 1999 and titled “DATABASE METHOD FOR PREDICTIVE CELLULAR BIOINFORMATICS,” which is incorporated herein by reference in its entirety and for all purposes, and in U.S. Patent Application Publication No. US 2005-0014217 A1, which was incorporated above.

The assays described herein can be carried out in many different apparatuses. Generally, the cell samples are provided as discrete cell cultures on one or more support structures. Depending on the type of support structure, the cells may grow in two-dimensions or three-dimensions. Examples of support structures include bare plastic supports that include nutrients, glass surfaces, extra-cellular matrices such as collagen or Matrigel (available from BD Biosciences, San Jose, Calif.), etc. Such structures can be provided in multiwell plates, such as 24-, 96-, or 384-well assay plates (e.g., Costar plates (Corning Life Sciences, New York, N.Y.) among others). An assay plate is a collection of wells arranged in an array with each well holding multiple cells which are exposed to a stimulus or which provide a control sample. In other embodiments, single sample holders can be used instead of multi-well plates.

Preparation of Cell Cultures is Well Known and Will not be Described in Detail Here. Available standard cell cultures (e.g., HUVEC, A549, A498, DU145, SKOV3 and SF268) may be suitable for some applications. However, in other applications such as those involving studies of a tumor from a particular patient, the cells may be obtained from a biopsy. Procedures for extracting, plating and culturing such cells are well known. In certain embodiments, hepatocytes are employed and these may be prepared and imaged as described in US Patent Publication No. US 2005-0014217 A1, previously incorporated by reference.

FIG. 2B shows a schematic block diagram of an image capture and image processing system (212) which can be used to capture and process the images of cells and store cell counts, phenotypic data, and other information used in boundary domain analyses described herein. This diagram is merely a non-limiting example. The depicted system (212) includes a computing device (214), which is coupled to an image processor (216) and is coupled to a database (218). The image processor receives information from an image-capturing device (220), which includes an optical device for magnifying images of cells, such as a microscope. The image processor and image-capturing device can collectively be referred to as the imaging system herein. The image-capturing device obtains information from a plate (222), which includes several wells providing sites for groups of cells. The computing device (214) retrieves the information, which has been digitized, from the image-processing device and stores such information into the database (218).

A user interface device (224), which can be a personal computer, a workstation, a network computer, a personal digital assistant, or the like, is coupled to the computing device. In the case of cells treated with a fluorescent marker, a collection of such cells is illuminated with light at an excitation frequency from a suitable light source such as a halogen-lamp, arc lamp or laser (not shown). A detector part of the image-capturing device is tuned to collect light at an emission frequency. In some embodiments this is a digital camera that is sensitive to light over a wide range of frequencies. One may use emission filters to control which light wavelengths hits the camera. Examples of suitable cameras are the Orca-100 from Hamamatsu (Hamamatsu City, Japan) or the CoolSNAP_{HQ}™ from Roper Scientific. The collected light is used to generate an image that highlights regions of high marker concentration.

The depicted apparatus also includes a fluidics system (not shown) for providing fluid to individual cell samples on the support. Such system can be employed to deliver a compound or other treatment to individual cell samples. An example is the fluidics system on the live cell imaging addition of the Axon ImageXpress (Axon Instruments/Molecular Devices Corporation, Union City, Calif.).

In one embodiment individual pipettes are provided for the individual wells of a support. Metered doses of a compound under investigation or a washing fluid are provided to each of the individual wells or to groups of individual wells. The fluidics control system can allow precise control of the drug wash off timing and flow conditions. The fluidics control system can allow fine control of fluid flow rates, delivery times, aspiration rates, and separation distance of the pipette or other delivery nozzle from the wells.

The apparatus may also allow careful control of illumination conditions. Obviously when fluorescent markers are used the apparatus must be able to illuminate at appropriate excitation frequencies and capture radiation at the signature emission frequencies. However, when imaging live cells it may also be important to ensure that the illumination conditions do not kill cells. Phototoxicity is a consideration. Imaging parameters to be optimized include the intensity of illumination (which may dictate magnification) and the frequency at which individual images are captured. Because different types of cells and different treatment regimens lead to different levels of sensitivity, systems allowing flexible illumination conditions can be used.

Other apparatus features include, optionally, mechanisms for controlling the environment in which the cells grow. Thus, the apparatus may include sub-systems for monitoring and controlling temperature and the atmospheric composition (e.g., carbon dioxide levels).

Examples of markers suitable for staining lipids in cells include Nile Red, DHPE and Bodipy®, all available from Invitrogen Inc., Carlsbad, Calif. By staining, for example, hepatocytes with a lipid marker, it is possible to draw conclusions about various conditions, such as steatosis (excessive accumulation of neutral lipids), phospholipidosis (accumulation of phospholipids).

As was discussed above, FIG. 1 shows an exemplary image of a hepatocyte culture where the granules are visible as tiny bright spots. This image will be used as an illustrative example in the following discussion. It should be noted that the principles described herein can be applied to any type of images that exhibit granules such as the ones shown in FIG. 1, and that the discussion below is not limited to hepatocytes, but can be extended to any other type of cells.

As was discussed above, the algorithm is based on finding edges that are close to local maxima. Therefore, in one embodiment, an “edge image” and a “local maxima image” are generated. First, the generation of the edge image will be explained, followed by the generation of the local maxima image.

Generally, edges in images can be described as areas with strong intensity contrasts, that is a significant change in intensity over a short distance (e.g., from one pixel to the next). There are a variety of ways to perform edge detection. Two categories are gradient methods and Laplacian methods. Here, a gradient method that uses a Sobel mask will be explained, although it should be understood that many other edge detection methods that are capable of correctly identifying edges in the cell image may be used as well, such as Prewitt, Roberts, Canny methods, and so on. Generally, the technique described here operates by generating a derivative image of the cell image and applying a thresholding technique to distinguish the “true” edges in the image from background noise.

The Sobel operator performs a 2-D spatial gradient measurement on the cell image to find an approximate absolute gradient magnitude at each pixel in the cell image. The Sobel edge detector uses a pair of 3×3 convolution masks. The first convolution mask Gx estimates the gradient in the x-direction (columns) and the other convolution mask Gy estimates the gradient in the y-direction (rows). It should be noted that the convolution masks are typically much smaller than the actual image. In this example, the masks are slid over the image, each manipulating a 3×3 square of pixels at a time. The actual Sobel masks are shown below:

$${G}_{x} = [ \begin{matrix}- 1 & 0 & 1 \\ - 2 & 0 & 2 \\ - 1 & 0 & 1\end{matrix} ] \qquad {G}_{y} = [ \begin{matrix}1 & 2 & 1 \\ 0 & 0 & 0 \\ - 1 & - 2 & - 1\end{matrix} ]$$

The masks are applied to the pixel values by centering the mask on each pixel in the original image. A new pixel value is calculated by multiplying each pixel value in the neighborhood (that is, the eight surrounding neighbors in the case of the Sobel masks shown above) with the corresponding weight in the convolution mask and summing these products. The magnitude of the gradient is then calculated using the formula:
|G|=\sqrt{(Gₓ)²+(G_{y})²}
As a result, each pixel in the image has an “absolute gradient value.” Typically, these values are either very low or very high (background and regions of high even intensity have essentially a zero derivative value), due to the application of the Sobel mask. Therefore application of a threshold value to the edge image can be employed in order to filter out background noise. In some embodiments the threshold value is chosen as the mean value of the absolute gradient values in the image, but it should be realized that other thresholds may be used as well, such as the median value or a Q75 value (upper 25^{th} percentile), or even a user-specified value. If the absolute gradient value for a pixel exceeds the threshold value, the pixel is labeled as an edge pixel, and otherwise it is labeled as a non-edge pixel. FIG. 3 shows the edge image corresponding to the image in FIG. 1. The edges detected in accordance with the above-described algorithm are shown in red.

After the edge image has been defined, the next step is to generate a local intensity maxima image. (Note that the local intensity maxima can be identified prior to or at the same time when edges are identified.) In one embodiment the local maxima are found by scanning the original image pixel by pixel and defining pixels as local maxima pixels if they have an intensity value that is equal or higher than the intensity value for its neighbors (e.g., eight immediate neighbors, that is, the eight pixels surrounding the pixel being examined). If this condition is true, then the pixel is labeled as a local maximum pixel. One reason for choosing an “equal or greater” condition as opposed to a simple “greater than” condition is that image granules tend to be “flat” in the middle of the granules, that is, intensity saturated. Thus, if only a “greater than” condition was used, there would be a significant risk of missing many granules. FIG. 4 shows a local intensity maxima image corresponding to the image in FIG. 1, where the local intensity pixels are shown in red. In one embodiment, for the pixels at the edges of the image, if the Sobel masks go beyond the dimension of the image, that is, when there are fewer than eight surrounding pixels, the pixels are always considered as non-edge pixels. As for the local maxima, the maximum was taken among the neighboring pixels that are within the images.

Next, the local intensity maxima detected above are dilated. In some embodiments, the dilation is to approximately “granule size.” At the 10× image magnification and a resolution of one micron per pixel used in FIG. 1, the granules typically have the size on the order of 3×3 pixels, so the local intensity maxima are dilated to 3×3 pixels. The reason for not dilating the local intensity pixels any further is that if there are larger groups of pixels with high intensity, these groups may arise from cells (or larger organelles such as nuclei) and not granules.

After the local intensity maxima have been dilated, the process identifies pixels of the dilated local maxima that intersect the detected edges intersect. If a dilated local intensity maximum intersects an edge, then the process determines that a granule edge has been identified at the intersection. As was discussed above, this determination can be made with reasonable certainty, since local maxima that arise from non-granule features such as cells or larger organelles are typically not within three pixels' distance from an edge, but tend to be in the middle of the cell or object, for example, inside the nucleus of the cell which is much larger than 3×3 pixels. Of course, this three-pixel distance is simply an example and may be modified as appropriate depending upon the relative size scales of granule and non-granule objects in the image, the magnification of the image, and the resolution of the image.

The granule edges were detected as described in the preceding section. For some applications, this may be all that is required to identify regions deemed to be granules. However, in some cases, it will be desirable to take additional steps to fully define granules in the image. Thus, in some embodiments, the edge intersection pixels identified in the preceding operation are dilated to define contiguous groups of pixels deemed to be granules. In some embodiments employing the magnification and resolution presented above, each intersecting edge pixel is dilated by a 3×3 pixel window to define the group of pixels belonging to a granule. FIG. 5 shows granules detected in the image of FIG. 1 by this algorithm, where the granules are shown in red color. This completes the process.

As indicated, all the steps discussed above have been discussed with respect to a sample image of hepatocytes obtained at a 10× magnification and with an image resolution of one micron per pixel. If other types of cells or other magnifications or staining agents are used, then the above parameters, such as the assumed granule size of 3×3 pixels, will need to be modified. However, such modifications are generally deemed to be within the skills of the ordinary artisan and will not be described in any detail here.

In order to derive biologically meaningful information from an analysis of cell images, it may be important to be able to distinguish the individual cells from each other by establishing the cell boundaries. The process of identifying regions of an image where cells or other objects are located is generically referred to as “segmentation,” and is a technique that is used in certain cell biology applications. In some embodiments, segmentation is performed by first generating a “nuclei mask” for the image, and then using this nuclei mask as a seed in a watershed algorithm to determine the boundaries of the individual cells. A detailed description of how to generate the nuclei mask can be found in U.S. patent application Ser. No. 09/792,013 by Cong et al. filed on Feb. 20, 2001 and titled EXTRACTING SHAPE INFORMATION CONTAINED IN CELL IMAGES, which is incorporated herein in its entirety. Appropriate watershed algorithms suitable for use are described in detail in L. Vincent and P. Soille, Watersheds in digital spaces: an efficient algorithm based on immersion simulations, IEEE Transactions on Patter Analysis and Machine Intelligence, 13:583-589, 1991, incorporated by reference herein for all purposes. Other techniques can be employed to segment cells, some of which employ gradient and/or thresholding algorithms. One technique that dilates a region occupied by nuclei is described in U.S. Pat. No. 6,956,961 of Cong, et al., titled “EXTRACTING SHAPE INFORMATION CONTAINED IN CELL IMAGES,” which is incorporated herein by reference for all purposes.

Once the image has been segmented, it can be combined with the granule image to yield information about granules on a per cell basis. On a cell level, the granularity information can be summarized in terms of, for example, the number of granules in the cell, the total size or area of the granules, the mean size of the granules, the total intensity of the granules and the average intensity of the granules. Similar summarizations can be made for the image as a whole, or for various groups of cells within the image, such as live cells versus dead cells, or for different cell types that are present in the same image. A more detailed analysis of granule distribution within individual cells can also be made, for example, by studying the number of granules within certain regions of the cells; at the cell periphery, at cell-cell contact areas, or at certain distances from the nucleus (for example, by creating concentric circles centered on the nucleus and counting the number of granules inside each circle).

Various types of pre- and post treatment analyses can also be made, for example, by counting the number of granules or measuring the total granule area within a cell before and after the cell is exposed to a drug or other compound of a particular concentration. This provides a convenient way for comparing the efficacy of stimuli on the cells with respect to the intra-cellular organelles or other granular structures. FIG. 6 shows a number of dose response curves, where the number of granules per cell (averaged over a population of cells) has been plotted versus the concentration of the different drugs. Without going into any specifics about the particular drugs used, it can be seen in FIG. 6 that the drugs Amiodarone, Methotrexate and Tetracycline appears to have the most significant response in the number of granules. FIG. 7 shows a similar set of curves as the curves in FIG. 6, but here the total area of the granules within a population of cells (on a per cell basis) has been plotted versus the concentration of the various drugs, and as expected, the same response is visible.

Not only drug treatment induces changes in the distribution of intra-cellular organelles or other granular structures. Particular pathologies that can also induce similar changes (and may be induced by exposure to drugs or other stimuli), and therefore it may be possible to identify various pathologies by performing granularity analyses as described above. For example, steatosis is a pathology characterized by the presence of abnormally large quantities of lipids within a cell. Steatosis may affect the cells of a variety of tissues and organs (e.g., hepatocytes in liver tissue). It reflects an impairment of the normal process of constant synthesis and breakdown of triglyceride fat. Steatosis may occur in the liver as a result of a variety of stresses, including exposure to poisons such as ethanol and the progression of certain diseases such as hepatitis C. The fat accumulates in vesicles that displace the cytoplasm. Such vesicles can be labeled and appear as granules in images of cells with steatosis, and thus be identified using the above methods. Steatosis is merely one example. Other examples of pathologies, such as phospholipidosis can be identified using image analysis of granules.

The methods and apparatus described herein can be implemented in digital electronic circuitry, or in computer hardware, firmware, software, or in combinations of them. The apparatus can be implemented in a computer program product tangibly embodied in a machine-readable storage device for execution by a programmable processor; and method steps can be performed by a programmable processor executing a program of instructions to perform granularity detection and image processing algorithms by operating on input data (e.g., images in a stack) and generating output (e.g., mechanisms of action for certain compounds). One or more computer programs can be provided that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, a computer system having a display device such as a monitor or LCD screen for displaying information to the user can be provided. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor optionally can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, may be received from and outputted to the network, for example, in the form of a computer data signal embodied in a carrier wave. The above-described devices and materials will be familiar to those of skill in the computer hardware and software arts.

It should be noted that various computer-implemented operations involving data stored in computer systems are employed. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein can be useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

Also provided are device, system or apparatus for performing the aforementioned operations. The system may be specially constructed for the required purposes, or it may be a general-purpose computer selectively activated or configured by a computer program stored in the computer. The processes presented above are not inherently related to any particular computer or other computing apparatus. Various general-purpose computers may be used with programs written in accordance with the teachings herein, or, alternatively, it may be more convenient to construct a more specialized computer system to perform the required operations.

A number of embodiments have been described. Nevertheless, it will be understood that various modifications may be made. For example, the above description has been primarily focused on hepatocytes and biological conditions that affect hepatocytes. It should however be noted that the same principles can be applied to other cells where the distribution of intra-cellular organelles and other granules within cells and among groups of cells are of interest. The granules representing the organelles have been identified above using a 3×3 matrix, but it should be realized that other sizes of matrices can be used as well, as can be determined based on the specific experimental and image processing conditions at hand. Accordingly, other embodiments are within the scope of the following claims.

1. A method for identifying intra-cellular granules within biological cells, the method comprising:
receiving an image of one or more cells in which a marker identifies at least one type of intra-cellular granules within the cells, the intra-cellular granules being visible in the image;
detecting edges and local intensity maxima in the received image;
dilating the detected local intensity maxima;
identifying intersection positions where the dilated local intensity maxima intersect detected edges in the image; and
dilating the identified intersection positions to define granules within biological cells of the image.

2. The method of claim 1, wherein dilating the detected local intensity maxima comprises dilating the maxima to a size that corresponds to an expected size of a granule in the image.

3. The method of claim 1, wherein the image comprises a digital representation of the one or more cells.

4. The method of claim 1, wherein the cells are hepatocyte cells.

5. The method of claim 1, wherein detecting edges comprises:
processing each pixel in the received image with a Sobel mask to generate a derivative image in which each pixel has an associated gradient value; and
designating a pixel as an edge pixel if the gradient value of the pixel is larger than a predetermined threshold value.

6. The method of claim 5, wherein the predetermined threshold value is one of: a median absolute gradient value for the pixels in the derivative image, a mean absolute gradient value for the pixels in the derivative image, and an upper 25^{th} percentile gradient value for the pixels in the derivative image.

7. The method of claim 1, wherein detecting local intensity maxima comprises:
comparing an intensity value of each pixel in the image with the intensity values of its neighboring pixels within a defined distance; and
designating a pixel as a local intensity maximum if its intensity value is greater than or equal to the intensity values of all its neighboring pixels.

8. The method of claim 1, wherein the received image is obtained with 10× magnification and dilating the detected local intensity maxima includes dilating the local intensity maxima to three by three pixels.

9. The method of claim 1, wherein the received image is obtained with 10× magnification and dilating the intersection positions includes dilating the intersection positions to three by three pixels to define a granule.

10. The method of claim 1, wherein the intra-cellular granules comprise one or more of the following types of cellular structures: lipid granules, lysosomes, and mitochondria.

11. The method of claim 1, further comprising segmenting the received image to identify cell boundaries for the individual cells in the field of one or more cells.

12. The method of claim 11, wherein segmenting includes using a watershed algorithm to segment the cells.

13. The method of claim 11, further comprising characterizing one or more features relating to the identified granules on a per cell or per cell domain basis.

14. The method of claim 13, wherein the features include one or more of: the number of granules, the total size or area of the granules, the total intensity of the granules and the average intensity of the granules.

15. The method of claim 13, wherein the features are characterized within one or more of the following types of regions: a particular area within a cell, a one or more whole cells within the image, and one or more groups of cells within the image.

16. The method of claim 13, wherein the image is a post treatment image of cells after treatment with a compound, and characterizing one or more features relating to the granules includes comparing the features of the post treatment image with a pre treatment image to identify the induced changes of features in the post treatment image.

17. The method of claim 16, further comprising:
generating dose curves showing the variation of features for different concentrations of a drug to determine an effective concentration of the drug.

18. A computer program product, stored on a machine-readable medium, for identifying intra-cellular granules within biological cells, comprising instructions operable to cause a computer to:
receive an image of one or more cells in which a marker identifies at least one type of intra-cellular granules within the cells, the intra-cellular granules being visible in the image;
detect edges and local intensity maxima in the received image;
dilate the detected local intensity maxima;
identify intersection positions where the dilated local intensity maxima intersect detected edges in the image; and
dilate the identified intersection positions to define granules within biological cells of the image.

19. The computer program product of claim 18, wherein the instructions to dilate the detected local intensity maxima comprise instructions to dilate the maxima to a size that corresponds to an expected size of a granule in the image.

20. The computer program product of claim 18, wherein the image comprises a digital representation of the one or more cells.

21. The computer program product of claim 18, wherein the cells are hepatocyte cells.

22. The computer program product of claim 18, wherein the instructions to detect edges comprise instructions to:
process each pixel in the received image with a Sobel mask to generate a derivative image in which each pixel has an associated gradient value; and
designate a pixel as an edge pixel if the gradient value of the pixel is larger than a predetermined threshold value.

23. The computer program product of claim 22, wherein the predetermined threshold value is one of: a median absolute gradient value for the pixels in the derivative image, a mean absolute gradient value for the pixels in the derivative image, and an upper 25^{th} percentile gradient value for the pixels in the derivative image.

24. The computer program product of claim 18, wherein the instructions to detect local intensity maxima comprise instructions to:
compare an intensity value of each pixel in the image with the intensity values of its neighboring pixels within a defined distance; and
designate a pixel as a local intensity maximum if its intensity value is greater than or equal to the intensity values of all its neighboring pixels.

25. The computer program product of claim 18, wherein the received image is obtained with 10× magnification and the instructions to dilate the detected local intensity maxima include instructions to dilate the local intensity maxima to three by three pixels.

26. The computer program product of claim 18, wherein the received image is obtained with 10× magnification and the instructions to dilate the intersection positions include instructions to dilate the intersection positions to three by three pixels to define a granule.

27. The computer program product of claim 18, wherein the intra-cellular granules comprise one or more of the following types of cellular structures: lipid granules, lysosomes, and mitochondria.

28. The computer program product of claim 18, further comprising instructions to segment the received image to identify cell boundaries for the individual cells in the field of one or more cells.

29. The computer program product of claim 28, wherein the instructions to segment include instructions to use a watershed algorithm to segment the cells.

30. The computer program product of claim 28, further comprising instructions to characterize one or more features relating to the identified granules on a per cell or per cell domain basis.

31. The computer program product of claim 30, wherein the features include one or more of: the number of granules, the total size or area of the granules, the total intensity of the granules and the average intensity of the granules.

32. The computer program product of claim 30, wherein the features are characterized within one or more of the following types of regions: a particular area within a cell, a one or more whole cells within the image, and one or more groups of cells within the image.

33. The computer program product of claim 30, wherein the image is a post treatment image of cells after treatment with a compound, and the instructions to characterize one or more features relating to the granules include instructions to compare the features of the post treatment image with a pre treatment image to identify the induced changes of features in the post treatment image.

34. The computer program product of claim 33, further comprising instructions to:
generate dose curves showing the variation of features for different concentrations of a drug to determine an effective concentration of the drug.

35. A method for identifying intra-cellular granules within biological cells substantially as hereinbefore described.

36. A computer program product, stored on a machine-readable medium, comprising instructions operable to cause a computer to identify intra-cellular granules within biological cells substantially as hereinbefore described.
